(19) United States
(12) Patent Application Publication
(10) Pub. No.: US 2019/0113471 A1
(43) Pub. Date: Apr. 18, 2019

(54) METHOD AND DEVICE FOR DETERMINING THE DEPTH OF A CRACK IN A SOLID

(71) Applicants: ESPCI, Paris (FR); CENTRE NATIONAL DE LA RECHERCHE SCIENTIFIQUE, PARIS CEDEX 16 (FR); SORBONNE UNIVERSITE, PARIS (FR)

(72) Inventors: Christine BOUE, NOISY LE GRAND (FR); Stephane HOLE, PARIS (FR)

(21) Appl. No.: 16/090,253

(22) PCT Filed: Mar. 30, 2017
(86) PCT No.: PCT/FR2017/050737

§ 371 Date: Sep. 30, 2018

(30) Foreign Application Priority Data
Mar. 31, 2016 (FR) 1652826

(51) Int. Cl. G01N 25/72; G01B 11/22; H04N 5/33

(52) U.S. Cl. CPC G01N 25/72; G01B 21/18; H04N 5/33; G01B 11/22

(57) ABSTRACT

The invention relates to a method (100) for determining the depth of a crack in a solid, which includes:
a step (105) of determining at least one speed for scanning a surface of the solid comprising the crack by a positioned heat source;
for every speed determined:
   a step (110) of scanning a portion of the surface of the solid, parallel to the general direction of the crack, by the heat source at said speed; and
   a step (115), synchronous with the scanning step, of detecting at least one value of a physical quantity representing the local heating of the surface of the scanned solid; and
a step (120) of determining the depth of the crack as a function of at least one value detected at least at one predetermined scanning speed.

### TECHNICAL FIELD OF THE INVENTION

The present invention envisages a method and a device for determining the depth of a crack in a solid. It applies in particular to the field of detecting cracks in structures used in the aeronautics, automobile and nuclear fields.

### STATE OF THE ART

Today, the detection of defects in metal parts and their qualification is done mainly using the Penetrant Testing technique.

The principle of penetrant testing is as follows:
Penetrant testing requires a very thorough cleaning of the surface, appropriate for the material to be tested and the pollutants to be removed from the surface. The interior of any discontinuities is also cleaned. The expert then coats the part to be tested with penetrant, by electrostatic spraying or by immersion (sometimes by aerosol spraying the penetrant, especially in the case of local penetrant testing of one or more identified areas of a large part).
The expert washes the part to remove the penetrant deposited on the surface. The washing conditions (pressure, temperature, duration) are determined by the penetrant range, so as to thoroughly wash the surface of the product without removing the penetrant that has penetrated into any defects open to the surface.
The expert dries the part in a heat chamber, sometimes using compressed air (dry air) at very low temperature or clean, dry, lint-free cloths.
Next, the expert applies the developer, as a powder, in suspension or in solution.
Then, the expert examines the part, in natural light for a colored penetrant or under UV (ultra-violet) light for a fluorescent penetrant, after a time period dependent on the testing method.
Lastly, the expert produces a test report in which the depth of any crack is estimated by the expert.

The drawbacks of this technique are that it is polluting, subject to the qualitative assessment of an expert, cannot be automated, and costly in consumable use.

There is currently no non-destructive quantitative method allowing the depth of a crack in a solid to be determined.

In particular, systems are known such as French patent application FR2995989 filed on Sep. 24, 2012. In these systems, a surface is heated with a modulated laser and the diffusion of this heating on the surface is detected synchronously to determine the depth of the crack. However, these systems only allow a local detection of the depth of the crack, ie for a portion of this crack. Thus, using such a system to determine the depth of a crack in its entirety requires the system to be applied successively (at different points), which has the disadvantage of requiring a long analysis time.

### SUBJECT OF THE INVENTION

The present invention aims to remedy all or part of these drawbacks.

To this end, according to a first aspect, the present invention envisages a method for determining the depth of a crack in a solid, which comprises:
a step of determining at least one speed for scanning a surface of the solid comprising the crack by a positioned heat source;
for every speed determined:
   a step of scanning a portion of the surface of the solid, parallel to the general direction of the crack, by the heat source at said speed; and
   a step, synchronous with the scanning step, of detecting at least one value of a physical quantity representing the local heating of the surface of the scanned solid; and
a step of determining the depth of the crack as a function of at least one value detected at one predetermined scanning speed at least.

Thanks to these provisions, the method enables a depth measurement that is non-destructive, repeatable, contactless and does not involve the use of pollutants. In addition, iteration of the scanning and detection steps provides the method with a high speed of determination.

In some embodiments, during the determination step, at least two speeds are determined.

In some embodiments, during the determination step, at least three speeds are determined.

In some embodiments, the detection step comprises a step of capturing at least three infrared images.

In some embodiments, the method that is the subject of the present invention comprises at least:
a step of calculating a value of the heating amplitude realized from captured infrared images; and/or
a step of calculating a value of the heating phase realized from captured infrared images.

The determination of the depth from amplitude values gives the determined depth greater precision in the case of significant depths, while the determination of depth from phase values gives the determined depth greater precision in the case of shallow depths. “Shallow depth” refers to a depth less than a predefined critical depth corresponding to a risk of damage to the solid. “Significant depth” refers to a depth greater than a predefined critical depth corresponding to a risk of damage to the solid.

In some embodiments, each image capture step is carried out at a frequency of vᵢ/L, where “vᵢ” is the scanning speed utilized in the scanning step and “L” is the total scanning distance of the heat source on the surface.

In some embodiments, each image capture step is carried out at frequencies of nvᵢ/L, where n≥1 and where “vᵢ” is the scanning speed utilized in the scanning step and “L” is the total scanning distance of the heat source on the surface.

In some embodiments, a depth of the crack determined during the determination step is determined as a function of at least three amplitude values and/or at least three phase values captured at three frequencies at least, determined from three different scanning speeds, or for one speed and three harmonic frequencies, or for a combination of different speeds and harmonic frequencies.

These embodiments enable a more sensitive determination of the depth of the crack based on an indicator formed of three phase and amplitude image calculations.

In some embodiments, the heat source is a continuous emission laser.

These embodiments allow linear heating.

In some embodiments, all the steps made up of the scanning, detection and determination steps are performed twice:
a first time in a first direction along the crack and
a second time along a second direction, opposite to the first direction, along the crack,
   the depth of the crack being determined as a function of the depths determined during each determination step.

In some embodiments, all the steps made up of the scanning, detection and determination steps are performed twice:
a first time in a first direction along a first side of the surface relative to the crack and
a second time along a second side of the surface, opposite to the first side relative to the crack,
   the depth of the crack being determined as a function of the depths determined during each determination step.

The embodiments according to the two scanning directions make it possible to compensate for the dissymmetry of the heat diffusion linked to the motion.

The embodiments on each side of the crack make it possible to minimize the possible differences in distance between the heated area and the crack.

These embodiments make it possible to increase the robustness of the method.

The determination of the depth is therefore the result of the mathematical combination of the results of different iterations.

According to a second aspect, the present invention envisages a device for determining the depth of a crack in a solid, which comprises:
a heat source;
a means for determining at least one scanning speed;
a means for scanning a portion of the surface of the solid, parallel to the general direction of the crack, by the heat source at each predetermined scanning speed;
a means, synchronous with the scanning means, for detecting at least one value of a physical quantity representing the local heating of the surface of the scanned solid, at each predetermined scanning speed; and
a means for determining the depth of the crack as a function of at least one value detected at least at one predetermined scanning speed.

As the particular aims, advantages and features of the device that is the subject of the present invention are similar to those of the method that is the subject of the present invention, they are not repeated here.

### BRIEF DESCRIPTION OF THE FIGURES

Other advantages, aims and particular features of the invention will become apparent from the non-limiting description that follows of at least one particular embodiment of the device and method that are the subjects of the present invention, with reference to drawings included in an appendix, wherein:

FIG. 1 represents, schematically and in the form of a logical diagram, a particular series of steps of the method that is the subject of the present invention;

FIG. 2 represents, schematically, a particular embodiment of the device that is the subject of the present invention;

FIG. 3 represents, schematically, a juxtaposition of actuation curves of the device that is the subject of the present invention;

FIG. 4 represents, schematically, an image calculated from iso-phases acquired during the capture step;

FIG. 5 represents, schematically, an image calculated from iso-amplitudes acquired during the capture step;

FIG. 6 represents, schematically and in the form of a logical diagram, a particular series of steps of the method that is the subject of the present invention;

FIG. 7 represents, schematically, a particular embodiment of the device that is the subject of the present invention;

FIG. 8 represents, schematically, the detection of heat at different analysis points in the device, as described with regard to FIG. 7;

FIG. 9 represents, schematically, a heat amplitude profile along a line perpendicular to the motion of the heat source;

FIG. 10 represents, schematically, a heat phase profile along a line perpendicular to the motion of the heat source;

FIG. 11 represents, schematically, a curve of the second-order spatial derivative (Laplacian) of the amplitude calculated at a point of the crack during the method that is the subject of the present invention;

FIG. 12 represents, schematically, a curve of the second-order spatial drift (Laplacian) of the phase calculated at a point of the crack during the method that is the subject of the present invention;

FIG. 13 represents two depth curves evaluated as a function of the position along the crack for two different values of crack widths;

FIG. 14 represents a crack line and paths taken by heat sources on either side of this crack and in two different directions for each side;

FIG. 15 represents four depth index curves as a function of the side and direction of scanning by the heat source;

FIG. 16 represents two depth curves evaluated for the crack line shown in FIG. 14;

FIGS. 17 to 20 show value curves of the distance between the position of the heat source and the crack; and

FIG. 21 shows a depth curve evaluated with the distance value curves of FIGS. 17 to 20 taken into account.

### DESCRIPTION OF EXAMPLES OF REALIZATION OF THE INVENTION

The present description is given in a non-limiting way, each characteristic of an embodiment being able to be combined with any other characteristic of any other embodiment in an advantageous way.

It is now noted that the figures are not to scale.

“Phase” refers to a delay in the propagation of heat within a solid.

“Terminal” refers to any device comprising a computing unit. Here, “terminal” means, for example:
a computer;
a digital tablet;
a smartphone; or
a server.

The general observation forming the basis of the present invention is the following:

A crack located in a heat diffusion area of a heat source positioned at the surface of a solid acts as a barrier altering the diffusion of the heat. The heat diffusion is also altered as a function of the duration of the heating of the surface of the solid. Therefore, for a continuous thermal excitation traversing a path parallel to the general direction of the crack, a point on the edge of the crack is heated during a length of time that depends on the speed of scanning by the heat source.

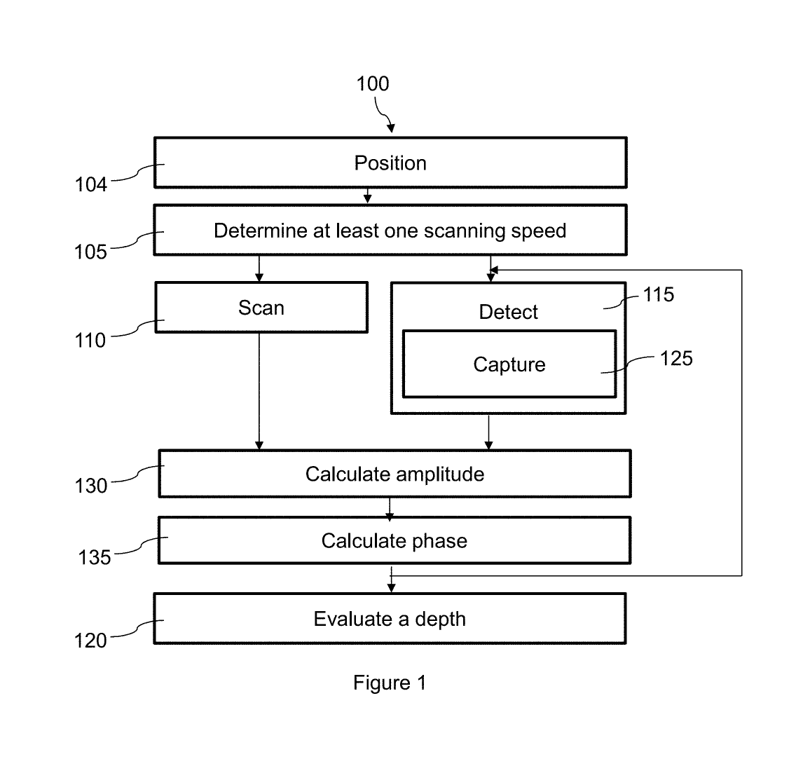

Based on this observation, in the particular embodiments described with reference to FIGS. 1 to 12, the acquisition of the temperature for each motion speed is measured by synchronous detection, synchronized with the motion of the heat source.

Here, “temperature variation phase” means the first harmonic phase of the periodized signal, where a period corresponds to a complete movement of the heat source along the scanning path.

These technical solutions make use of the images of phase and temperature variation amplitude obtained at different speeds of movement of the thermal excitation, extracting from them the thermal signature of cracks by means of a spatial operator, such as the Laplacian or gradient. The analysis of these images as a function of a length representative of the thermal diffusion length gives an evaluation of the depth of the crack.

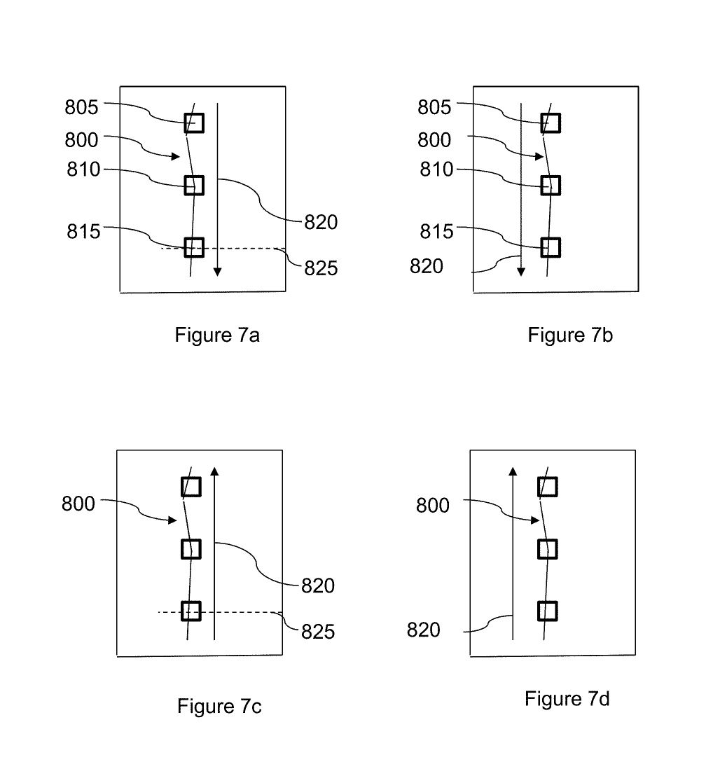

FIG. 7 shows a crack fissure 800 and a scanning path 820 parallel to the general direction of the crack 800. One can see, for example, three analysis points for the thermal signature:
a first point 805 is located on the crack near a starting point of the scan performed by the heat source;
a second point 810 is located on the crack opposite an intermediate point of the scan performed by the heat source;
a third point 815 is located on the crack near a finish point of the scan performed by the heat source.

These distinct analysis points each correspond, for example, to a pixel of a captured image of the crack.

The operation illustrated in FIG. 7 utilizes four scans of the surface of the solid by the heat source, consisting of one forward and one return scan of each side of the crack.

Here, “side of the crack” refers to a portion of the surface located on the surface positioned on one side of the general axis formed by the crack.

“Forward” and “return” refer to scanning a portion of the surface in one direction and scanning the same portion of the surface in an opposite direction. These scans can be immediately sequential or performed independently.

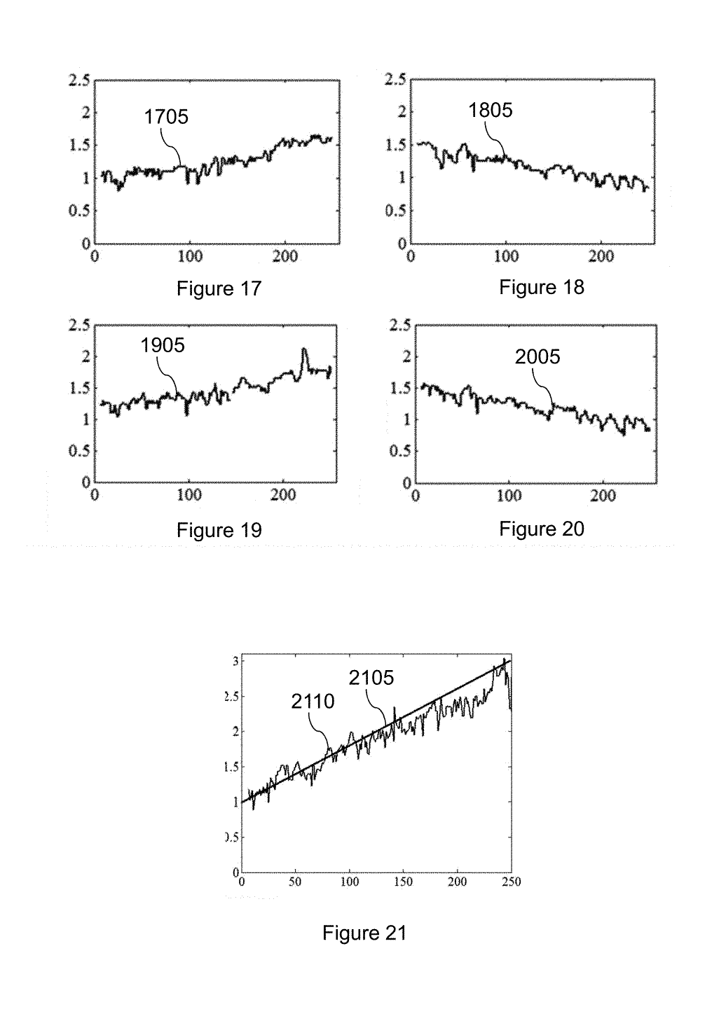

FIGS. 17 to 20 show, on the y-axis, an evaluation in millimeters of the distance between the position of the heat source and the crack, for a crack with a non-constant depth, on the x-axis, of between 1 and 3 millimeters and a length of 20 millimeters. One can see in these figures:
in FIG. 17, a curve 1705 plotting the distance between the portion heated by the heat source and the crack when the heat source is moved in a first direction on a first side of the crack;
in FIG. 18, a curve 1805 plotting the distance between the portion heated by the heat source and the crack when the heat source is moved in the first direction on a second side of the crack;
in FIG. 19, a curve 1905 plotting the distance between the portion heated by the heat source and the crack when the heat source is moved in a second direction on a first side of the crack;
in FIG. 20, a curve 2005 plotting the distance between the portion heated by the heat source and the crack when the heat source is moved in a second direction on a second side of the crack.

FIG. 21 shows a curve 2110 representative of the depth of the crack evaluated from curves 1705, 1805, 1905 and 2005. This curve 2110 is similar to the expected depth line 2105.

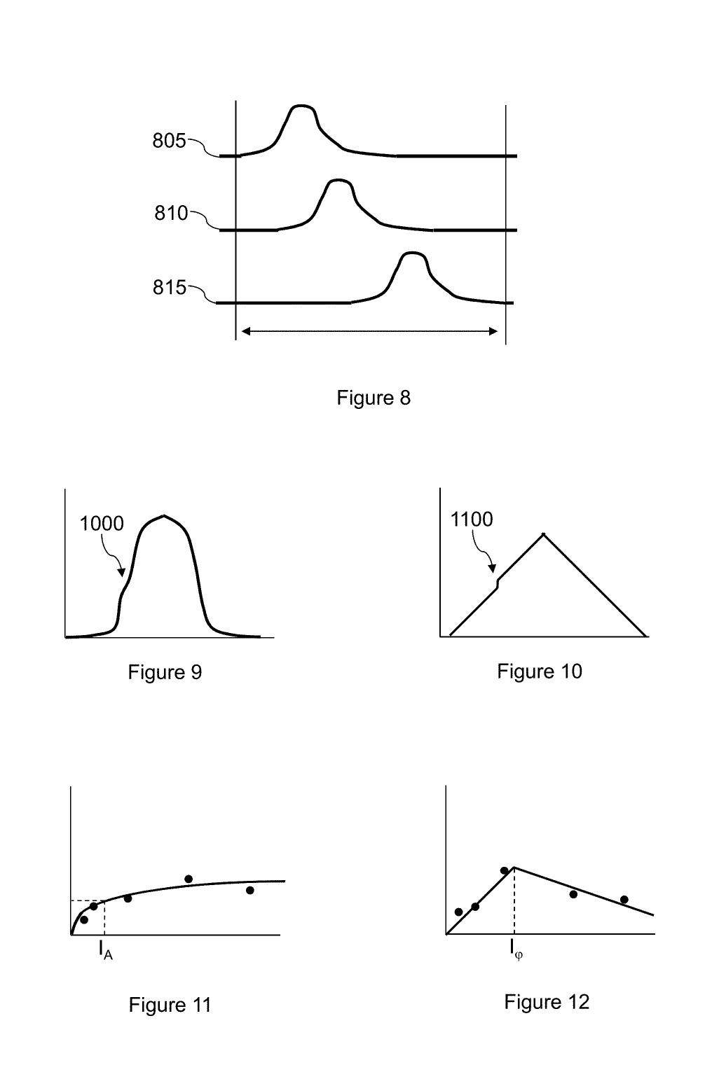

FIG. 8 shows, schematically, for each analysis point, the value of the heating measured from the heat source being turned on for a length of time, referred to as “period”, which corresponds to the time required for the heat source to perform a scan.

Therefore, by varying the scanning speed, one varies this pseudo-period, and thus the corresponding pseudo-frequency.

When, for a given scanning speed, synchronous detection is performed at the location of the crack, a phase and amplitude value of the first pseudo-harmonic signal for a given pseudo-frequency can be extracted.

When a crack is present, the amplitude and phase profile shows a break, the signature of this break signaling the presence of a crack, and the analysis of this break at different frequencies enabling the depth of the crack to be deduced.

An example of such breaks is notably visible in FIGS. 9 and 10, these FIGS. 9 and 10 respectively representing an amplitude profile and a phase profile along the line 825.

In FIG. 9 it can be seen that the amplitude reaches its maximum along the path traversed by the heat source, the amplitude having roughly a Gaussian shape on either side of this maximum. At the location of the crack, the decrease in temperature shows a break 1000 characteristic of the presence of a crack.

In FIG. 10 it can be seen that, at the location of the crack, the phase curve, which shows a linear decrease on either side of the heated area, shows a break 1100 characteristic of the presence of a crack.

FIG. 1 shows a logical diagram of particular steps of an embodiment of the method 100 that is the subject of the present invention. This method 100 for determining the depth of a crack in a solid comprises:
a step 105 of determining at least one speed for scanning a surface of the solid comprising the crack by a positioned heat source;
for every speed determined:
   a step 110 of scanning a portion of the surface of the solid, parallel to the general direction of the crack, by the heat source at said speed; and
   a step 115, synchronous with the scanning step, of detecting at least one value of a physical quantity representing the local heating of the surface of the scanned solid; and
a step 120 of determining the depth of the crack as a function of at least one value detected at one predetermined scanning speed at least.

Preferably, during the determination step, at least two speeds are determined.

Preferably, during the determination step, at least three speeds are determined.

Prior to the determination step 105, the method 100 comprises a step 104 of positioning a heat source at a sufficiently short distance from the crack that the heat diffused reaches the crack during the measurement time.

This positioning distance is broadly equal to the critical depth of the crack for the solid in question.

Here, “critical depth of the solid” means a predefined depth, which depends on the field of application of the invention and on the location of the crack in the solid. This critical depth corresponds to a depth considered, in the field, as having a risk of causing damage to the solid.

The step 105 of determining at least one scanning speed is performed, for example, by an electronic control circuit of a terminal associated to a scanning means configured to perform the scanning step 110. This electronic control circuit sends the scanning means a signal representative of each scanning speed value to the utilized. Preferably, each scanning speed determined is different.

The range of speeds, annotated “vᵢ”, is determined by the formula:

$${v}_{i} = \frac{DL}{{πμ}_{i}^{* 2}} ,$$

where:
“D” is the thermal diffusivity of the solid;
“L” is the length of the scanning path. It can correspond to the length of the crack on the surface of the solid; and
“μᵢ*” is the pseudo-length of the thermal diffusion as defined below, the values of μᵢ being between 0.1 d and 10 d, where “d” is the distance separating the heat source from the crack to be characterized.

The objective of the scanning step 110 is to thermally load the crack by moving the heat source near, and preferably along, the crack. At each iteration, annotated “i”, the same scanning path is followed at a different speed, determined during the determination step 105. Thus, a circular area of the surface portion to be heated, with a radius annotated “r”, is heated during an approximate length of time 2r/vᵢ. For a scanning path with a total length annotated “L”, the total heating time is equal to L/vᵢ.

During the scanning step 110, the heat source is applied to a defined heating path on the portion of the surface in question. Preferably, this path is a line segment. This heat source is, preferably, a beam emitted by a continuous emission laser. On contact with the solid, the beam heats the solid locally.

The scanning step 110 is performed, for example, by utilizing the scanning means. The scanning means consists, for example, of a set of two mirrors free to rotate, a first mirror moving the beam emitted by the laser along a first axis as a function of the rotation of this first mirror, and a second mirror moving the beam along a second axis, orthogonal to the first axis, as a function of the rotation of this second mirror. These provisions enable the beam to be moved on the portion of the surface in an orthogonal reference space. The speed of rotation of either of the mirrors depends on the speed determined during the determination step 105. The scanning step 110 is performed once for each speed determined. Such a set of mirrors, associated to a source of laser radiation, is extensively described in the literature and the particular implementation of such a set of mirrors is therefore not repeated here.

Because the local heating time is variable as a function of the scanning time, the heat of the heated portion is diffused more or less in the solid as a function of the determined scanning speed, this heat acting as a sensor of the depth of the crack.

The detection step 115 is performed, for example, by an infrared camera successively capturing, at a determined frequency, a plurality of infrared images representative of a portion of the surface heated by the heat source.

Preferably, this detection step 115 comprises a step 125 of capturing at least three infrared images. During this capture step 125, the infrared flow is measured synchronized with the movement of the heat source. The capture is performed by a fixed infrared camera.

In some variants, the heat source is a laser fixed to a mobile mount.

In some variants, the heat source is fixed and the sample mobile.

Preferably, the method 100 comprises at least:
a step 130 of calculating a value of the heating amplitude realized from captured infrared images; and/or
a step 135 of calculating a value of the heating phase realized from captured infrared images.

Each calculation step, 130 and 135, is performed by the infrared camera. Each calculation step, 130 and 135, is performed at a pseudo-frequency of vᵢ/L and possibly at its harmonic frequencies according to the number of speeds taken into account.

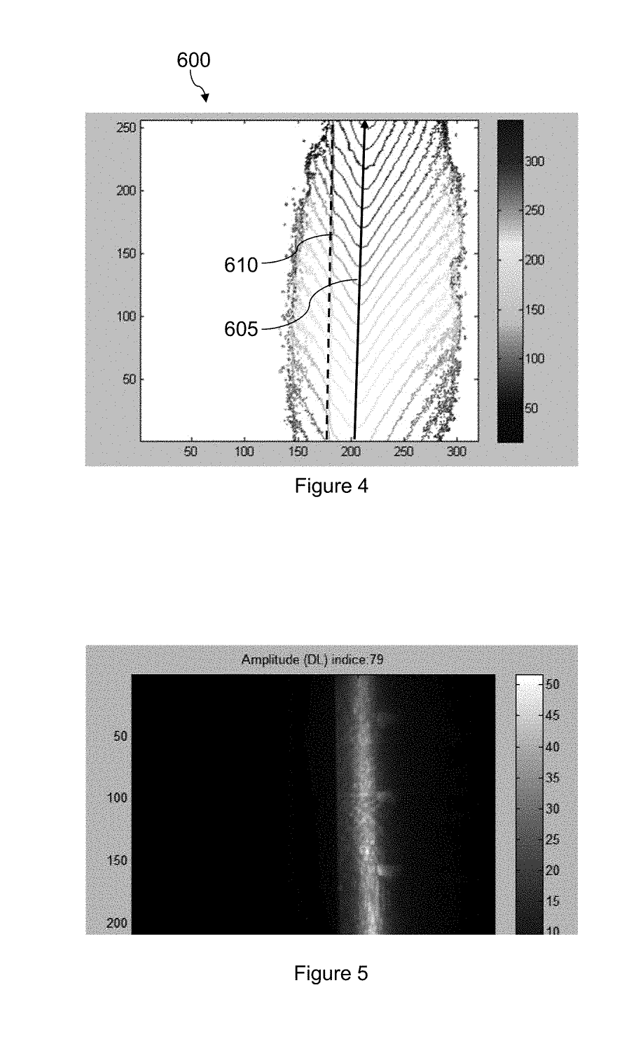

FIG. 4 shows, schematically, an example of an image representative of iso-phases obtained during a scan of the heat source.

It shows, in particular, the path 605 traversed by the heat source during a scan, and the imprint 610 of the crack causing a break in the iso-phases for a given distance of the scanning path.

Here, “pseudo-length of the thermal diffusion” means a distance annotated “μ*”, with

$$μ *= \frac{\sqrt{DL}}{π {v}_{i}}$$

where D is the thermal diffusivity of the solid in m²/s.

During the step 120 of determining the depth of the crack, the following processing is applied to each amplitude image captured:
calculating the spatial derivative, for example first- or second-order, and in a preferred embodiment second-order (Laplacian), of each amplitude calculated for each movement speed determined;
obtaining a set of points, which can be adjusted by a curve representative of the spatial derivative of the amplitude as a function of μ*, an example of such a pseudo-curve being illustrated in FIG. 11; and
determining a value IA corresponding to the value of μ* for a value of the curve such as, for example, 70% of the maximum of this curve.

FIG. 5 shows, schematically, an example of an image representative of iso-amplitudes obtained during a scan of the heat source.

During the step 120 of determining the depth of the crack, the following processing is applied to each phase image captured:
calculating the spatial derivative, for example first- or second-order, and in a preferred embodiment second-order (Laplacian), of each phase calculated for each movement speed determined;
obtaining a set of points, which can be adjusted by a curve representative of the spatial derivative of the phase as a function of μ*, an example of such a curve being illustrated in FIG. 12; and
determining an indicator IA corresponding to the value of μ* for the maximum value of the curve, for example.

This processing can be performed as a result of multiplying the amplitude image by the phase image.

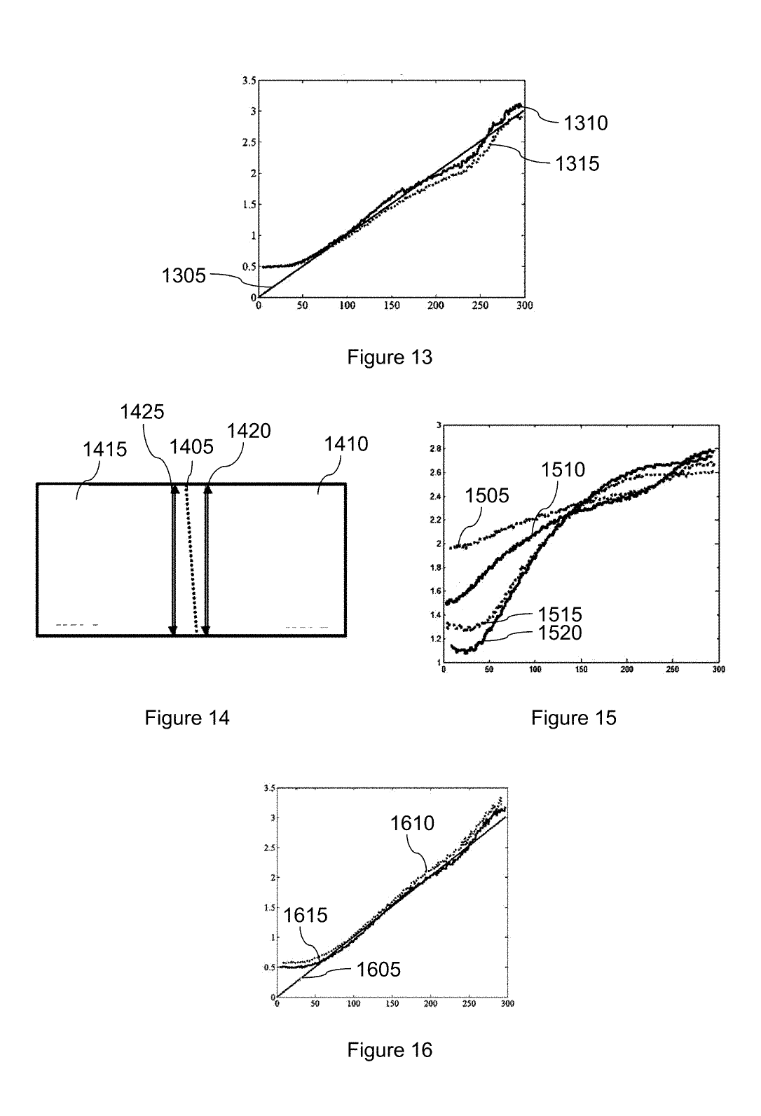

FIG. 13 shows, on the y-axis, an evaluation in millimeters of the depth along a crack, for a crack with a non-constant depth, on the x-axis, of between 0 and 3 millimeters for two crack widths, one 40 micrometers and the other 80 micrometers. This reference space shows three curves:
a line 1305 corresponding to the expected depth and, therefore, accurately measuring the depth of the crack;
a first curve 1315 plotting the evaluated depth for a crack width of 40 micrometers; and
a second curve 1310 plotting the evaluated depth for a crack width of 80 micrometers.

It is noted that the evaluated depths are practically similar to the expected depths, represented by the line 1305.

Based on at least one of the two values of the indicators determined with reference to the phase and amplitude curve, the value of the depth of the crack can be determined.

This depth value can be equal to the value of one of the indicators or to the product of the two, for example.

In some embodiments, each image capture step 125 is carried out at a frequency of vᵢ/L, where “vᵢ” is the scanning speed utilized in the scanning step and “L” is the total scanning distance of the heat source on the surface.

In some embodiments, each image capture step 125 is carried out at frequencies of nvᵢ/L, where n≥1 and where “vᵢ” is the scanning speed utilized in the scanning step and “L” is the total scanning distance of the heat source on the surface.

In some preferred embodiments, a depth of the crack determined during the determination step 120 is determined as a function of at least three amplitude values and/or at least three phase values captured at three frequencies at least, determined from three different scanning speeds, or for one speed and three harmonic frequencies, or for a combination of different speeds and harmonic frequencies.

In some embodiments, all the steps made up of the steps of scanning 110, detection 115 and determination 120 are performed twice:
a first time in a first direction along the crack and
a second time along a second direction, opposite to the first direction, along the crack,
   the depth of the crack being determined as a function of the depths determined during each determination step.

In some embodiments, all the steps made up of the steps of scanning 110, detection 115 and determination 120 are performed twice:
a first time in a first direction along a first side of the surface relative to the crack and
a second time along a second side of the surface, opposite to the first side relative to the crack,
   the depth of the crack being determined as a function of the depths determined during each determination step.

FIG. 14 shows, schematically:
a crack 1405 delimiting two sides, 1410 and 1415, of a surface;
a scanning path, 1420 and 1425, by the heat source on each side of the crack 1405;

FIG. 15 shows, on the y-axis, an indicator value of depth, in an arbitrary unit, along the crack 1405 shown in FIG. 14. This reference space shows four curves:
a first curve 1505 representative of the depth indicator observed when the heat source scans a side 1410 of the crack 1405 from bottom to top;
a second curve 1510 representative of the depth indicator observed when the heat source scans a side 1415 of the crack 1405 from bottom to top;
a third curve 1515 representative of the depth indicator observed when the heat source scans a side 1410 of the crack 1405 from top to bottom;
a fourth curve 1520 representative of the depth indicator observed when the heat source scans a side 1415 of the crack 1405 from top to bottom;

FIG. 16 shows, on the y-axis, an evaluation in millimeters of the depth along a crack, for a crack with a non-constant depth, on the x-axis, of between 0 and 3 millimeters. This reference space shows three curves:
a line 1605 corresponding to the expected depth and, therefore, accurately measuring the depth of the crack;
a first curve 1615 plotting the depth evaluated by calculating the average between the first curve 1505 and the fourth curve 1520; and
a second curve 1610 plotting the depth evaluated by calculating the average between the second curve 1510 and the third curve 1515.

One notes, therefore, that the evaluated depths are similar to the expected depth.

FIG. 3, shows, schematically, a juxtaposition of actuation curves of the detection means utilized during the detection step. These curves have time for the x-axis 505 and each has a non-specified physical dimension for the y-axis.

The first curve 510 shows a pulse signal for starting the detection means, such as an infrared camera.

Conjointly with this pulse signal, the second curve 515 corresponds to a signal actuating the heat source, such as a laser source for example. It can be seen that the heat source is active during the total heating time, whose duration is equal to L/v, where “v” is a particular value of the scanning speed vᵢ.

The third curve 520 shows the distance between the position of the heat source on the portion of the surface of the sold to be heated and the initial position of the heat source.

Thus, it can be seen that at the end of the total heating time, the heat source is at the farthest point from the initial position of the heat source, the distance represented by the curve 520 being a linear function of the elapsed heating time.

After the total heating time, the heat source is deactivated and directed to the initial position of this heat source. During this redirection, the path traversed by the heat source can be identical to the path traversed during the scanning step.

It can also be noted that the duration of the return can be different from the duration of the scanning step 110.

To implement the method 100, a device comprises:
a first terminal controlling:
   the switching on of a laser source;
   the movements of the beam emitted by the laser source over the surface of the solid;
   the triggering of the capture means capturing at least three infrared images; and
a second terminal receiving each captured image and comprising a means for determining the depth of the crack as a function of at least three captured images.

In some variants, as described with regard to FIG. 3 below, the first and second terminal are one and the same.

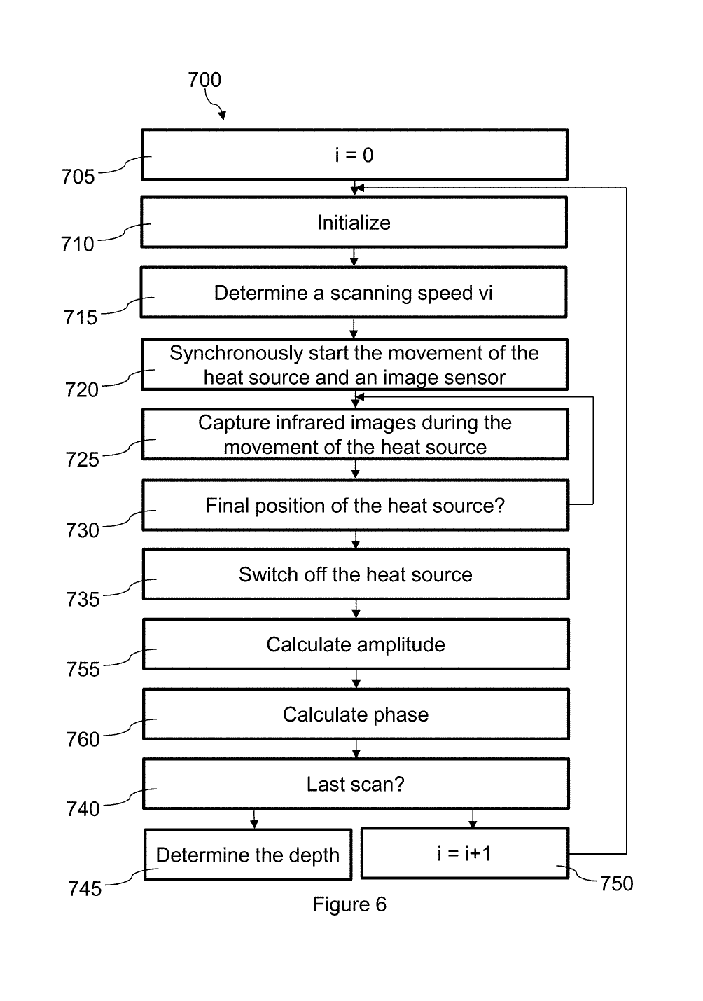

FIG. 6 shows a logical diagram of particular steps of the method 700 that is the subject of the present invention. This method 700 comprises:
a step 705 of initializing an incremental variable, annotated “i”;
a step 710 of initializing the heat source in position as a function of the direction of this source's movement along the crack and the side of the crack against which the heat source is positioned;
a step 715 of determining a speed of movement of the heat source depending on the incremental value;
a step 720 of synchronously starting the heat source and an infrared image sensor;
a step 725 of capturing infrared images along the movement of the heat source at a known sampling rate of the capture system;
a step 730 of determining the position of the heat source, such that the capture step 725 takes place while the heat source is not in the final position;
if the heat source is in the final position, a step 735 of switching off the heat source;
a step 740 of comparing the incremental value to a predefined value corresponding to the desired maximum value of the incremental value;
if the incremental value is different from the maximum value, a step 750 of incrementing the incremental value, the method 700 restarting at the initialization step 710;
if the incremental value is equal to the maximum value, a step 745 of determining the depth of the crack from each image captured at each movement speed determined.

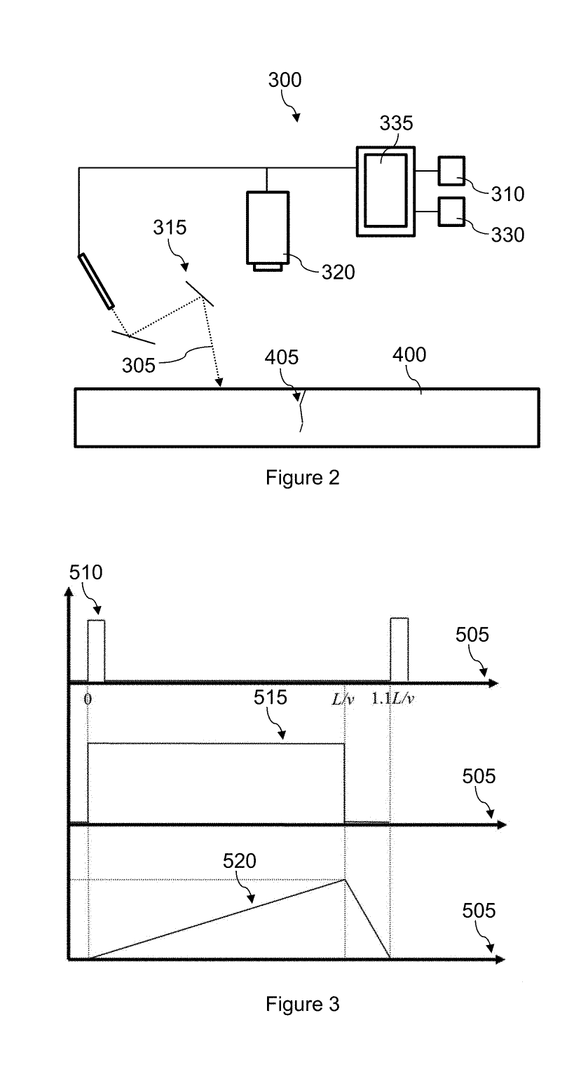

FIG. 2 shows, schematically, a particular embodiment of the device 300 that is the subject of the present invention. This device 300 for determining the depth of a crack 405 in a solid 400 comprises:
a heat source 305;
a means 310 for determining at least one scanning speed;
a means 315 for scanning a portion of the surface of the solid, along the crack, by the heat source at each scanning speed determined;
a means 320, synchronous with the scanning means, for detecting at least one value of a physical quantity representing the local heating of the surface of the scanned solid; and
a means 330 for determining the depth of the crack as a function of at least one value detected at least at one predetermined scanning speed.

In some preferred embodiments, the scanning step comprises a step of capturing at least three amplitude values and/or at least three phase values captured at three frequencies at least, determined from three different scanning speeds, or for one speed and three harmonic frequencies, or for a combination of different speeds and harmonic frequencies.

The determination means 310 is, for example, an electronic control circuit of a terminal 335.

The scanning means 315 consists, for example, of a set of mirrors enabling the movement of a beam emitted by a laser source, this beam acting as a heat source 305 in contact with a surface of the solid 400.

The detection means 320 is, for example, an infrared camera moving synchronously with the scanning performed by the heat source 305.

The determination means 330 is, for example, an electronic calculation circuit configured to perform the determination step 120 described with regard to FIG. 1.

1. Method for determining the depth of a crack in a solid, comprising:
a step of determining at least one speed for scanning a surface of the solid comprising the crack by a positioned heat source;
for every speed determined:
a step of scanning a portion of the surface of the solid, parallel to the general direction of the crack, by the heat source at said speed; and
a step synchronous with the scanning step, of detecting at least one value of a physical quantity representing the local heating of the surface of the scanned solid; and
a step of determining the depth of the crack as a function of at least one value detected at least at one predetermined scanning speed.

2. Method according to claim 1, wherein, during the determination step at least two speeds are determined.

3. Method according to claim 2, wherein, during the determination step at least three speeds are determined.

4. Method according to one of claim 1, wherein the detection step comprises a step of capturing at least three infrared images.

5. Method according to claim 4, which comprises at least:
a step of calculating a value of the heating amplitude realized from captured infrared images; and/or
a step of calculating a value of the heating phase realized from captured infrared images.

6. Method according to claim 5, wherein each image capture step is carried out at a frequency of vᵢ/L, where “vᵢ” is the scanning speed utilized in the scanning step and “L” is the total scanning distance of the heat source on the surface.

7. Method according to claim 5, wherein each image capture step is carried out at frequencies of nvᵢ/L, where n≥1 and where “vᵢ” is the scanning speed utilized in the scanning step and “L” is the total scanning distance of the heat source on the surface.

8. Method according to claim 1, wherein a depth of the crack determined during the determination step is determined as a function of at least three amplitude values and/or at least three phase values captured at three frequencies at least, determined from three different scanning speeds, or for one speed and three harmonic frequencies, or for a combination of different speeds and harmonic frequencies.

9. Method according to claim 1, wherein the heat source is a continuous emission laser.

10. Method according to one of claim 1, wherein all the steps made up of the steps of scanning, detection and determination are performed twice:
a first time in a first direction along the crack and
a second time along a second direction, opposite to the first direction, along the crack,
the depth of the crack being determined as a function of the depths determined during each determination step.

11. Method according to one of claim 1, wherein all the steps made up of the steps of scanning, detection and determination are performed twice:
a first time in a first direction along a first side of the surface relative to the crack and
a second time along a second side of the surface, opposite to the first side relative to the crack,
the depth of the crack being determined as a function of the depths determined during each determination step.

12. Device for determining the depth of a crack in a solid, comprising:
a heat source;
a determiner for determining at least one scanning speed;
a scanner for scanning a portion of the surface of the solid, parallel to the general direction of the crack, by the heat source at each predetermined scanning speed;
a detector, synchronous with the scanning means, for detecting at least one value of a physical quantity representing the local heating of the surface of the scanned solid; and
a determiner for determining the depth of the crack as a function of at least one value detected at least at one predetermined scanning speed.
